(19) United States
(12) Patent Application Publication
(10) Pub. No.: US 2006/0291491 A1
(43) Pub. Date: Dec. 28, 2006

(54) Wireless LAN unit

(75) Inventors: Yoshinori Sakata, Osaka (JP); Tomohiro Konishi, Osaka (JP); Keiichi Tsuchiya, Osaka (JP)

Correspondence Address: Christopher J. Fildes;Fildes & Outland, P.C., Suite 2, 20916 Mack Avenue, Gross Pointe Woods, MI, 48236, US

(73) Assignee: CONTEC CO., LTD.

(21) Appl. No.: 11/438,184

(22) Filed: May 22, 2006

(30) Foreign Application Priority Data
Jun. 24, 2005 (JP) 2005-184180

(51) Int. Cl. H04L 12/56; H04L 12/66

(52) U.S. Cl. 370/401; 370/463

(57) ABSTRACT

A wireless LAN board includes a wired LAN connector connected to a wired LAN board, an antenna connecting terminal connected with an antenna for performing radio signal transmission/reception, a wired LAN section connected to the wired LAN connector to transmit/receive a data signal to/from the wired LAN board, a wireless LAN section connected to the antenna connecting terminal to transmit/receive a data signal to/from an external device with the use of a radio signal through the antenna, and a controller section connected to the wired LAN section and the wireless LAN section to control the wired LAN section and the wireless LAN section.

### BACKGROUND OF THE INVENTION

1. Field of the Invention

The present invention relates to a wireless LAN unit for connecting a plurality of terminal devices to each other through a wireless line.

2. Description of the Related Art

A LAN unit makes a computer connectable to a network. At present, a majority of computers are equipped with LAN units because of development of a super high-speed communication network and popularization of the Internet. As one example of such LAN units, there is a wireless LAN unit capable of performing wireless data communications.

For example, JP2003-167647A discloses a wireless LAN card as a publicly known wireless LAN unit.

The wireless LAN card disclosed in this publication establishes data communications between adjacent computers in a wireless manner with the use of infrared rays, radio frequencies or the like and, therefore, has an advantage that a PC is readily placed or changed. Moreover, the wireless LAN card is attached to either a portable computer or a desktop computer.

In general, upon use of such a wireless LAN card, if a personal computer (hereinafter, abbreviated as “PC”) is installed with Windows (registered trademark) as its operating system (hereinafter, abbreviated as “OS”), driver software can be loaded thereon by inserting the wireless LAN card into a PCI slot (one example of extension slot).

However, the configuration of the aforementioned publicly known wireless LAN unit (wireless LAN card) has the following problems.

If the wireless LAN unit is used in a PC installed with an OS other than Windows, it is necessary to load driver software prepared separately, which requires burdensome work.

Moreover, in the case of using a PC installed with a special OS, there is no driver software corresponding to such an OS; therefore, there is a problem that the wireless LAN unit cannot be used.

Further, processing generally becomes heavy due to the driver software of the wireless LAN unit. Therefore, if the throughput of a PC is low, there is a problem that this PC cannot obtain sufficient transmission speed.

### SUMMARY OF THE INVENTION

Accordingly, it is an object of the present invention to provide a wireless LAN unit that can be used without depending on an OS and driver software.

In order to achieve this object, a wireless LAN unit of the present invention includes a wired LAN connecting terminal connected to a wired LAN unit of a terminal device, a reception unit connecting terminal connected with a reception unit for performing radio signal transmission/reception, a wired LAN section connected to the wired LAN connecting terminal to transmit/receive a data signal to/from the wired LAN unit, a wireless LAN section connected to the reception unit connecting terminal to transmit/receive a data signal to/from an external device with the use of a radio signal through the reception unit, and a controller section connected to the wired LAN section and the wireless LAN section to control the wired LAN section and the wireless LAN section. Herein, the wireless LAN unit is used by being attached to the terminal device and connected to the wired LAN unit of the terminal device through a cable.

With this configuration, a signal transmission source (e.g., motherboard) itself of a terminal device transmits/receives a data signal to/from a wired LAN unit as conventionally. In addition, the wired LAN unit transmits/receives a data signal to/from a wireless LAN unit, and a controller section of the wireless LAN unit controls the data signal transmission/reception.

### BRIEF DESCRIPTION OF THE DRAWINGS

FIG. 1 is a block diagram of a wireless LAN board according to one embodiment of the present invention;

FIG. 2 illustrates attachment of the wireless LAN board;

FIG. 3 illustrates connection of the wireless LAN board;

FIG. 4 illustrates a flow of a data signal in a basic structure A at the time of assigning the wireless LAN board as a slave;

FIG. 5 illustrates an overall configuration of the basic structure A at the time of assigning the wireless LAN board as a slave;

FIG. 6 illustrates a flow of a data signal in a basic structure B at the time of assigning the wireless LAN board as a master;

FIG. 7 illustrates an overall configuration of the basic structure B at the time of assigning the wireless LAN board as a master;

FIG. 8 illustrates an overall configuration of an applied example 1 of the wireless LAN board;

FIG. 9 illustrates a flow of a data signal in an applied example 2 of the wireless LAN board;

FIG. 10 illustrates an overall configuration of the applied example 2 of the wireless LAN board;

FIG. 11 illustrates an overall configuration of an applied example 3 of the wireless LAN board; and

FIG. 12 illustrates an overall configuration of an applied example 4 of the wireless LAN board.

### DESCRIPTION OF THE PREFERRED EMBODIMENT

Hereinafter, description will be given of an embodiment of the present invention with reference to the drawings.

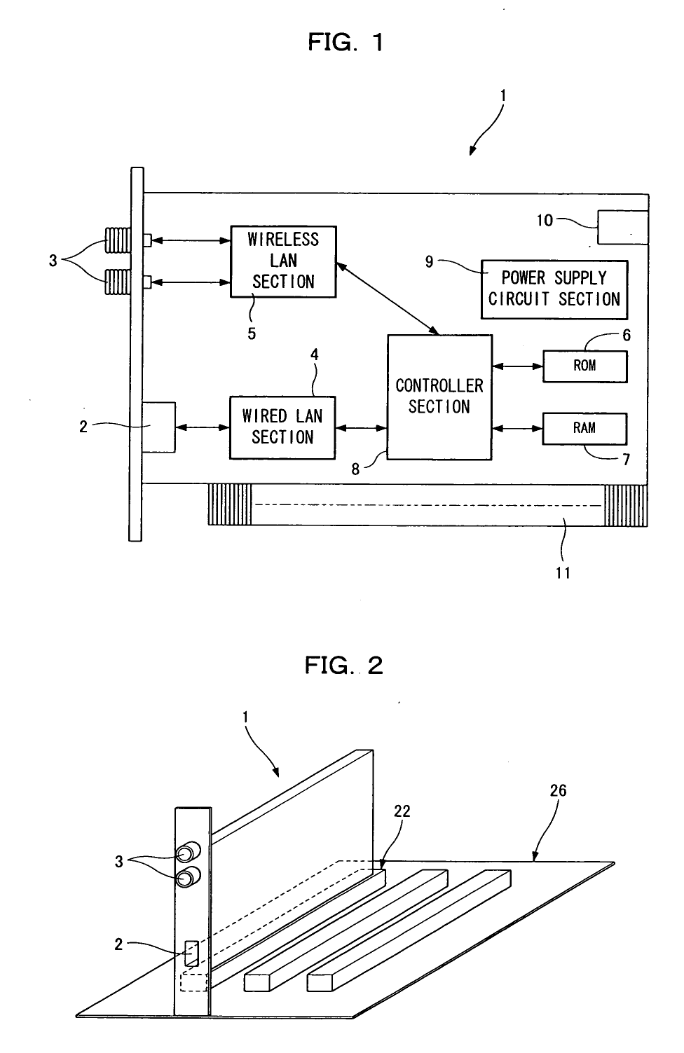

A wireless LAN unit of the present invention is used by being attached to a terminal device and connected to a wired LAN unit of the terminal device through a cable. As illustrated in FIGS. 1 and 2, the wireless LAN unit is formed as a wireless LAN board attached to a personal computer.

A wireless LAN board (one example of wireless LAN unit) 1 includes a wired LAN connector (one example of wired LAN connecting terminal) 2, an antenna connecting terminal (one example of reception unit connecting terminal) 3, a wired LAN section 4, a wireless LAN section 5, a ROM 6, a RAM 7, a controller section 8, a power supply circuit section 9, an auxiliary power supply connector (one example of auxiliary power supply terminal) 10, and a PCI connector (one example of fixing section) 11.

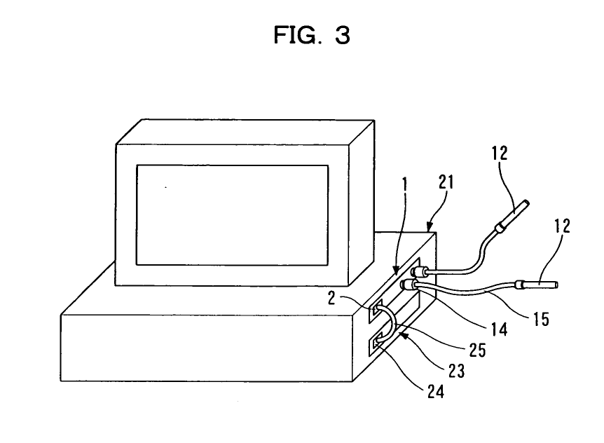

As illustrated in FIG. 3, the wired LAN connector 2 is of a modular jack type, which is a LAN port connected to an existing wired LAN board (one example of wired LAN unit) 23 mounted to a personal computer (hereinafter, abbreviated as “PC”) (one example of terminal device) 21 through a LAN cable 25.

The number of antenna connecting terminals 3 is two (plural). As illustrated in FIG. 3, antennas (one example of reception unit) 12 for performing radio signal transmission/reception are connected to the antenna connecting terminals 3. Herein, each of the antennas 12 is provided at one end of a cable 15 having the other end provided with a connector 14 connected to the antenna connecting terminal 3. The antenna 12 may be directly provided to the connector 14.

The wired LAN section 4 is connected to the wired LAN connector 2 and the controller section 8, receives, from the wired LAN connector 2, a first data signal as a data signal according to standards of the existing wired LAN board 23 mounted to the PC 21, converts this first data signal into a second data signal as a data signal according to standards of the controller section 8 to output the second data signal to the controller section 8, and converts the second data signal input from the controller section 8 into the first data signal to output the first data signal to the wired LAN connector 2.

The wireless LAN section 5 is connected to the antenna connecting terminal 3 and the controller section 8, demodulates a radio signal input from the antenna connecting terminal 3 and received by the antenna 12, converts the demodulated signal into the second data signal to output the second data signal to the controller section 8, and converts the second data signal input from the controller section 8 into the radio signal, i.e., demodulates the second data signal to output the radio signal to the antenna connecting terminal 3. Herein, the wireless LAN section 5 selects the radio signal from the sensitive one of the antennas 12.

The controller section 8 includes a CPU, is connected to the wired LAN section 4, the wireless LAN section 5, the ROM 6 and the RAM 7, and controls data signals for the wired LAN section 4 and the wireless LAN section 5 on the basis of a program stored in the ROM 6.

The power supply circuit section 9 supplies power supply voltage to the respective components.

The wireless LAN board 1 is attached to a PCI slot (one example of extension slot) 22 formed on a motherboard 26 of the PC 21 through the PCI connector 11, and is supplied with electric power from the PC 21 through the PCI slot 22.

Herein, the auxiliary power supply connector 10 is supplied with standby electric power for the wireless LAN board 1 and, also, is supplied with operating electric power after activation of the PC 21, at the time of a WOL (Wake on LAN, which will be described later) use.

Examples of the control of data signals for the wired LAN section 4 and the wireless LAN section 5, performed by the controller section 8, include signal transmission/reception, signal encryption/decryption in a wireless LAN, changeover between a master and a slave, observation of a communication state (storage of a log), and the like.

Hereinafter, description will be given of action of the aforementioned embodiment.

At the time of using the wireless LAN board 1, as illustrated in FIG. 2, the wireless LAN board 1 is attached to the PCI slot 22 of the PC 21 and, as illustrated in FIG. 3, the wired LAN connector 2 of the wireless LAN board 1 is connected to the connector 24 of the existing wired LAN board 23 in the PC 21 through the LAN cable 25. Then, the connector 14 is connected to the antenna connecting terminal 3, for attachment of the antenna 12.

Thus, the wireless LAN board 1 is fixed by being attached to the PCI slot 22 through the PCI connector 11, and is supplied with power supply voltage from the PCI bus through the PCI connector 11.

As described above, in the wireless LAN board 1 attached to the PCI slot 22, when the PC 21 transmits a data signal to an external device, under the control by the controller section 8, the wired LAN section 4 converts, into the second data signal, the first data signal input from the existing wired LAN board 23 in the PC 21 through the LAN cable 25, the controller section 8 encrypts the second data signal input from the wired LAN section 4, the wireless LAN section 5 converts, into the radio signal, the encrypted second data signal input from the controller section 8, and this radio signal is transmitted to the external device through the antenna 12.

Also in the wireless LAN board 1, when the PC 21 receives a data signal from an external device, under the control of the controller section 8, the wireless LAN section 5 converts, into the second data signal, the radio signal received by the antenna 12, the controller section 8 decrypts the second data signal input from the wireless LAN section 5, the wired LAN section 4 converts, into the first data signal, the decrypted second data signal input from the controller section 8, and this first data signal is transmitted to the existing wired LAN board 23 through the LAN cable 25.

As described above, a data signal transmission/reception source (e.g., motherboard) itself of the PC 21 transmits/receives a data signal to/from the existing wired LAN board 23 as conventionally. Further, the wireless LAN board 1 transmits/receives a data signal to/from the PC 21 through the existing wired LAN board 23. Therefore, even when the PC 21 is installed with an OS other than Windows, driver software for wireless LAN becomes unnecessary.

In addition, since the controller section 8 performs processing for a data signal, such as encryption/decryption, distributed processing can be performed by the CPU on the motherboard of the PC 21 and the controller section 8. Herein, at the time of transmitting/receiving the data signal in a wireless manner, the data signal is subjected to encryption as described above for the purpose of preventing information leakage by the interception of the data signal by a third party.

In the case that the aforementioned PC has an unused PCI slot, when the wireless LAN board 1 is attached to this PCI slot, a wireless LAN system can be constructed with the use of the existing PC.

Next, description will be given of a function of assigning the wireless LAN board 1 as a master or a slave. Herein, the assignment of the wireless LAN board 1 as either a master or a slave is preset to the controller section 8.

(Basic Structure A)

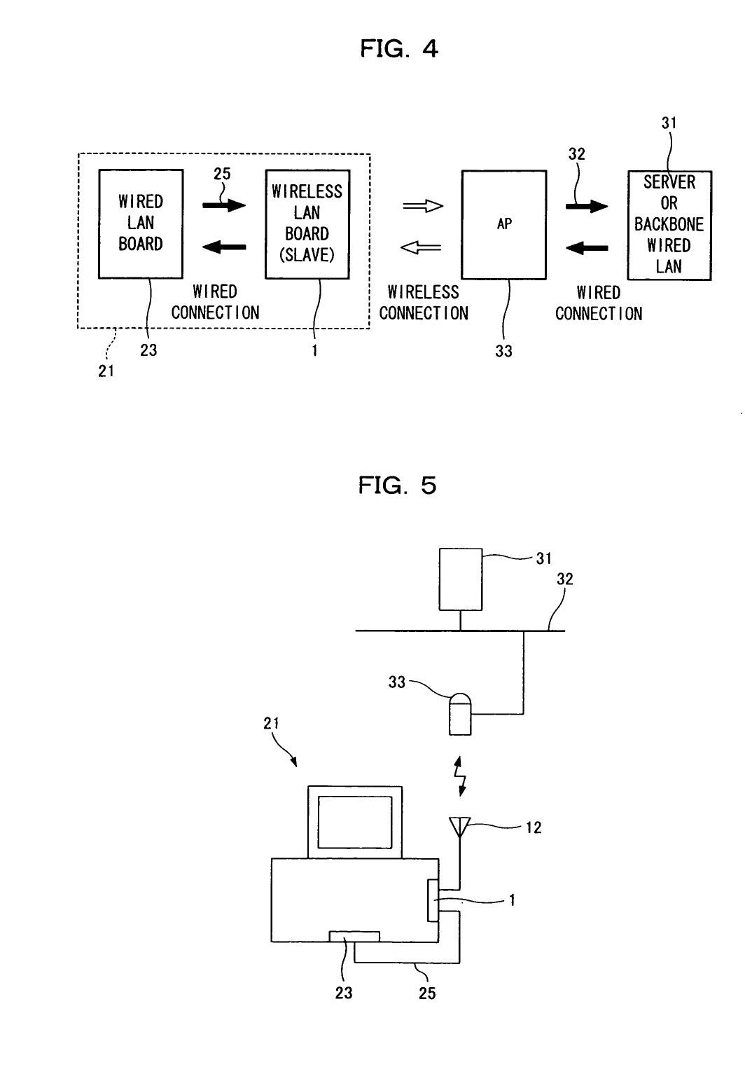

First, description will be given of a basic structure A in which the wireless LAN board 1 attached to the PC 21 is assigned as a slave, i.e., the PC 21 is used as a slave, with reference to FIGS. 4 and 5.

When the PC 21 is used as a slave, as illustrated in FIG. 4, there is provided a wireless access point (hereinafter, abbreviated as “AP”) 33 connected to a master (a sever 31 for providing a data signal and the like) through a cable with a backbone wired LAN 32 interposed therebetween (or directly connected to the server 31 through a cable). The PC 21 is connected to the AP 33 in a wireless manner, i.e., performs wireless communications with the AP 33. Herein, the existing wired LAN board 23 establishing PCI connection with a motherboard or the like is connected to the wireless LAN board 1 through the LAN cable 25.

More specifically, as illustrated in FIG. 5, when the wireless LAN board 1 is attached to the PC 21 and is connected to the existing wired LAN board 23 as described above and the controller section 8 is assigned as a slave, the controller section 8 assigns the PC 21 as a slave. Then, when the controller section 8 receives a data signal transmitted from the AP 33 through the antenna 12 and the wireless LAN section 5 to confirm presence of the AP 33, a data signal indicating that the PC 21 is a slave is transmitted from the antenna 12 through the wireless LAN section 5 on the basis of the program stored in the ROM 6, and the AP 33 transmits/receives a data signal to/from the PC 21 in a wireless manner with the PC 21 used as a slave.

As described above, when the PC 21 equipped with the wireless LAN board 1 is assigned as a slave, the PC 21 transmits/receives a data signal to/from only the AP 33 in a wireless manner.

(Basic Structure B)

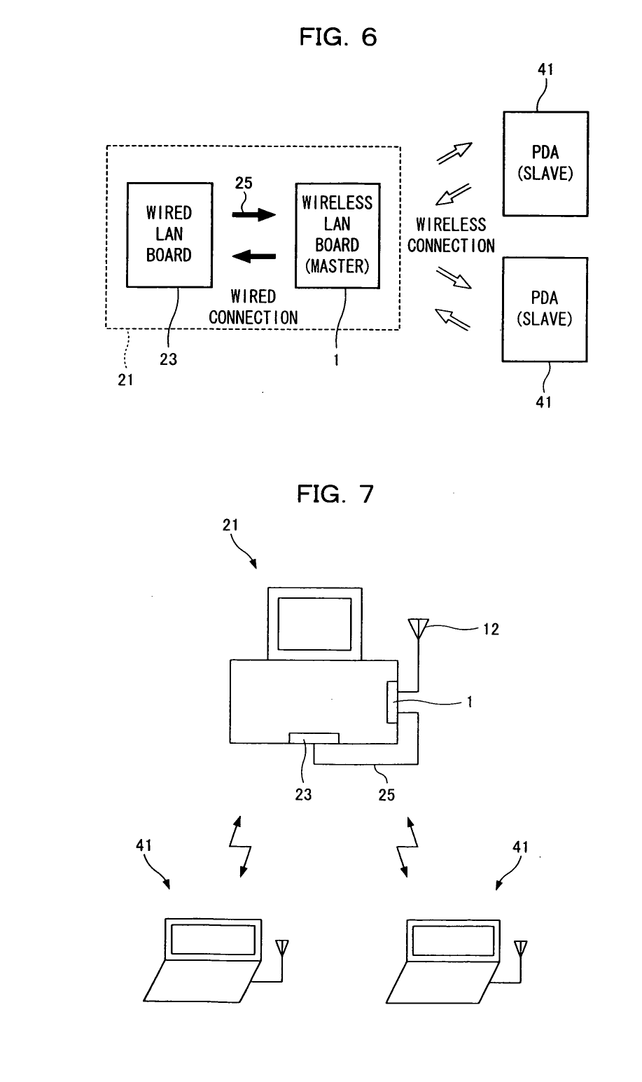

Next, description will be given of a basic structure B in which the wireless LAN board 1 attached to the PC 21 is assigned as a master, i.e., the PC 21 is used as a master, with reference to FIGS. 6 and 7.

When the PC 21 is used as a master and, for example, a plurality (two in FIG. 6) of PDAs (Personal Digital Assistances) 41 are used as slaves, as illustrated in FIG. 6, the PC 21 is connected to each PDA 41 in a wireless manner. Herein, the existing wired LAN board 23 establishing PCI connection with a motherboard or the like is connected to the wireless LAN board 1 through the LAN cable 25.

More specifically, as illustrated in FIG. 7, when the wireless LAN board 1 is attached to the PC 21 and is connected to the existing wired LAN board 23 as described above and the controller section 8 is assigned as a master, the controller section 8 assigns the PC 21 as a master. Then, the controller section 8 transmits a data signal indicating that the PC 21 is a master with the use of the antenna 12 through the wireless LAN section 5 on the basis of the program stored in the ROM 6. Each PDA 41 recognizes the data signal to transmit a data signal indicating that the PDA 41 is a slave to the PC 21. When the controller section 8 receives the data signal indicating that the PDA 41 is a slave through the antenna 12 and the wireless LAN section 5 and confirms presence of the PDAs 41, the PC 21 transmits/receives a data signal to/from each PDA 41 in a wireless manner with the PC 21 used as a master.

As described above, when the PC 21 equipped with the wireless LAN board 1 is assigned as a master, the PC 21 transmits/receives a data signal to/from each PDA 41 in a wireless manner with the PC 21 used as a master. That is, the PC 21 serves as the AP.

Next, description will be given of a WOL (Wake On LAN) function executable when the wireless LAN board 1 is used, with reference to FIG. 5. Herein, the wireless LAN board 1 attached to the PC 21 is supplied with standby electric power from the auxiliary power supply connector 10. The WOL function refers to a function of activating a PC connected to a LAN with the use of another PC through the network. The WOL function can be used even when the wireless LAN board 1 is assigned as either a master or a slave.

For example, when the server 31 extracts data from the PC 21 in the state that the main power supply of the PC 21 is turned off after the completion of operations, the server 31 transmits a magic packet (activation signal) to the wireless LAN board 1 of the PC 21 through the AP 33. Then, the wireless LAN board 1 sends this magic packet to the wired LAN board 23, so that the main power supply of the PC 21 is turned on. Accordingly, the data signal transmission/reception source (e.g., motherboard) of the PC 21 is activated; thus, the server 31 can extract data from the PC 21.

Hereinafter, description will be given of applied examples each using the wireless LAN board 1.

### APPLIED EXAMPLE 1

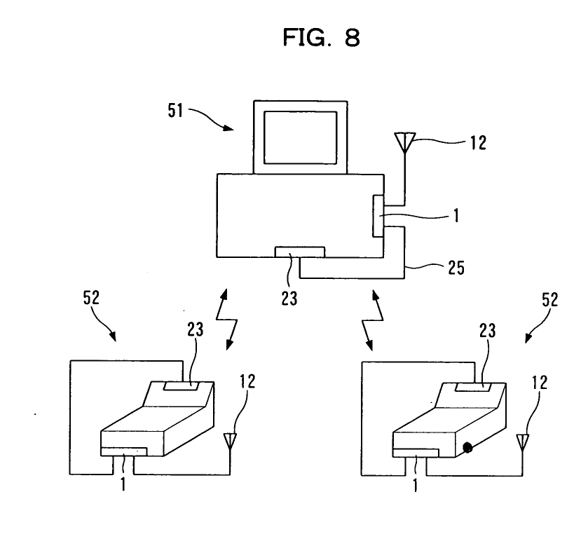

Description will be given of an applied example 1 according to the basic structure B with reference to FIG. 8.

When the wireless LAN board 1 is attached to a host computer 51 for managing sales information of POS (Point Of Sales system) terminals (one example of terminal device) 52 installed with an special OS and is connected to the existing wired LAN board 23 as described above and the controller section 8 is assigned as a master, the controller section 8 assigns the host computer 51 as a master.

Also, the wireless LAN board 1 is attached to each POS terminal 52 and is connected to the existing wired LAN board 23 as described above, and the controller section 8 assigns each POS terminal 52 as a slave.

With this configuration, also in a POS system using a POS terminal installed with a special OS, the host computer 51 can transmit/receive a data signal to/from each POS terminal 52 in a wireless manner with the host computer 51 used as a master. Thus, it is unnecessary to connect between the host computer 51 and each POS terminal 52 through a cable such as a LAN cable.

### APPLIED EXAMPLE 2

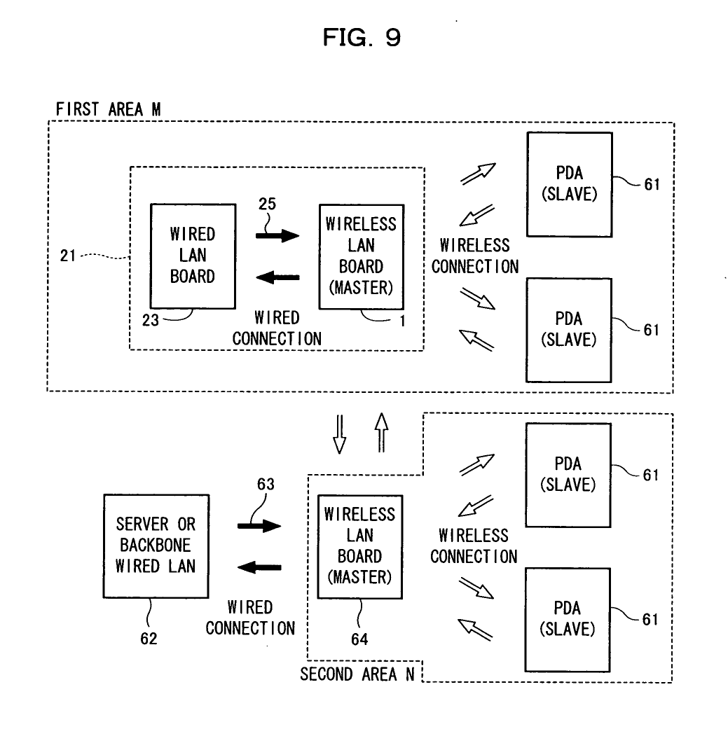

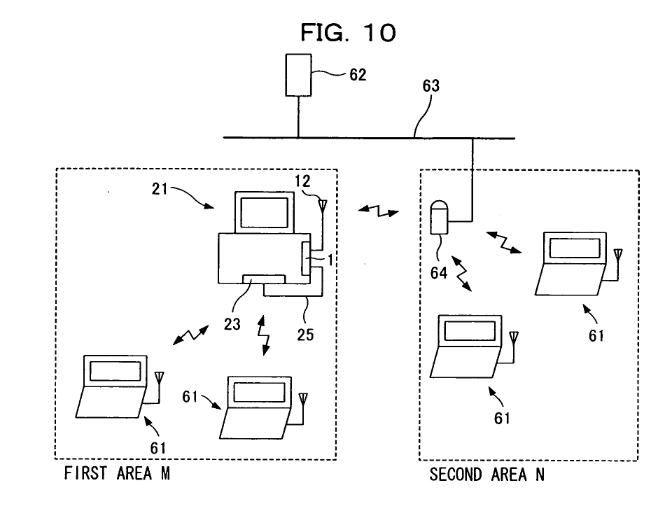

Description will be given of an applied example 2 in which the PC 21 is used as a master, with reference to FIGS. 9 and 10.

In the case that the PC 21 is used as a maser in a first area M and, for example, a plurality (four in FIG. 9) of PDAs 61 are used as slaves, as illustrated in FIG. 9, there is provided an AP 64 connected to a server 62 for providing a data signal and the like through a cable with a backbone wired LAN 63 interposed therebetween and connected to each PDA in a second area N in a wireless manner, and the PC 21 is connected to the AP 64 in a wireless manner, i.e., performs wireless communications with the AP 64. Herein, the existing wired LAN board 23 establishing PCI connection with a motherboard or the like is connected to the wireless LAN board 1 through the LAN cable 25.

More specifically, as illustrated in FIG. 10, when the wireless LAN board 1 is attached to the PC 21 and is connected to the existing wired LAN board 23 as described above and the controller section 8 is assigned as a master, the controller section 8 assigns the PC 21 as a master. Next, a data signal indicating that the PC 21 is a master is transmitted from the antenna 12 through the wireless LAN section 5 on the basis of the program stored in the ROM 6. Each PDA 61 in the first area M recognizes the aforementioned data signal to transmit a data signal indicating that each PDA 61 is a slave to the PC 21. When the controller section 8 receives the data signal indicating that each PDA 61 is a slave through the antenna 12 and the wireless LAN section 5 to confirm presence of the PDAs 61 in the first area M, the PC 21 transmits/receives a data signal to/from each PDA 61 in the first area M in a wireless manner with the PC 21 used as a master. Herein, each PDA 61 in the second area N performs data signal transmission/reception in a wireless manner with the AP 64 used as a master.

The server 62 transmits/receives a data signal in a wireless manner, through the AP 64 appropriately, to/from the PC 21 and each PDA 61 connected to the AP 64 or the PC 21 as a master.

As described above, when the PC 21 equipped with the wireless LAN board 1 is assigned as a master, the PC 21 transmits/receives a data signal to/from each PDA 61 in the first area M in a wireless manner with the PC 21 used as a master. That is, the PC 21 serves as an AP in the first area M.

### APPLIED EXAMPLE 3

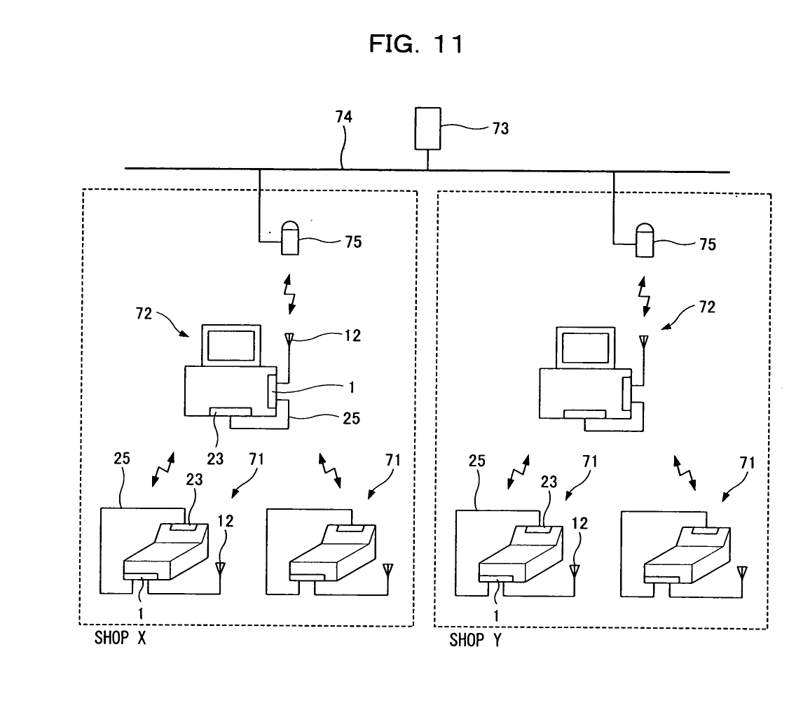

Description will be given of an applied example 3 with reference to FIG. 11.

In shops X and Y, respectively, there are provided a plurality (two in FIG. 11) of POS terminals 71 each installed with a special OS, a host computer 72 for managing sales information of the POS terminals 71, and an AP 75 connected to a management computer 73 for managing sales information of all the shops through a cable with a backbone wired LAN 74 interposed therebetween (or directly connected to the management computer 73 for managing data signals).

In the case that the host computer 72 is used as a master and each POS terminal 71 is used as a slave in the respective shops X and Y, as illustrated in FIG. 11, the wireless LAN board 1 is attached to the host computer 72 and is connected to the existing wired LAN board 23 as described above, and the controller section 8 assigns the host computer 72 as a master. Similarly, the wireless LAN board 1 is attached to each POS terminal 71 and is connected to the existing wired LAN board 23 as described above, and the controller section 8 assigns each POS terminal 71 as a slave.

With this configuration, in a POS system using a POS terminal installed with a special OS, the host computer 72 can transmit/receive a data signal to/from each POS terminal 71 in a wireless manner with the host computer 72 used as a master. Further, since the host computer 72 and each POS terminal 71 perform wireless communications with each other, it is unnecessary to connect between the host computer 72 and each POS terminal 71 through a cable such as a LAN cable.

It is to be noted that the management computer 73 transmits/receives a data signal to/from the host computer 72 in a wireless manner through the AP 75 appropriately.

Now, description will be given of the WOL (Wake On LAN) function in the applied example 3. Herein, the wireless LAN board 1 attached to the host computer 72 is supplied with standby electric power from the auxiliary power supply connector 10.

For example, in the case that sales information extracted from the POS terminals 71 in each shop by the host computer 72 during the daytime is extracted from the host computer 72 after close of the shops, the management computer 73 transmits a magic packet from each AP 75 to the wireless LAN board 1 of each host computer 72 to turn on the main power supply of each host computer 72, thereby extracting sales information of each host computer 72.

### APPLIED EXAMPLE 4

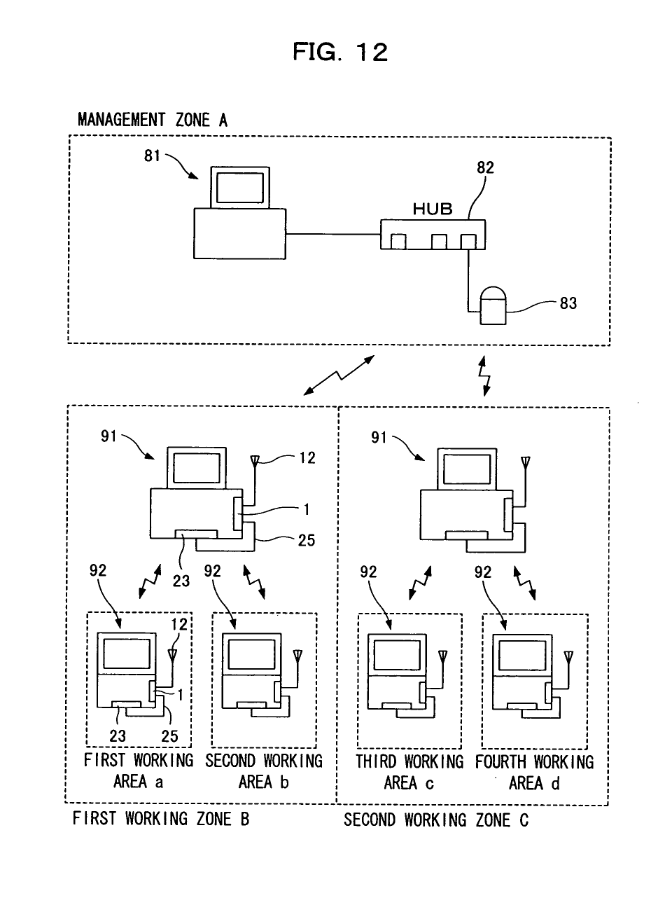

Description will be given of an applied example 4 with reference to FIG. 12.

As illustrated in FIG. 12, in a management zone A, there are placed a management computer 81 for performing production management in a factory, a HUB 82 connected to the management computer 81, and an AP 83 connected to the HUB 82.

Further, a first working zone B is divided into a first working area a and a second working area b, and a second working zone C is divided into a third working area c and a fourth working area d.

In each of the working zones B and C, there is placed a host computer (one example of terminal device) 91 for managing a production status of each zone. In each of the areas a, b, c and d, there is placed an industrial PC (one example of terminal device) 92 for managing a production status of each area.

In the case that the host computer 91 in each of the working zones B and C is used as a master and the industrial PC 92 in each of the areas a, b, c and d is used as a slave, as illustrated in FIG. 12, the wireless LAN board 1 is attached to the host computer 91 and is connected to the existing wired LAN board 23 as described above, and the controller section 8 assigns the host computer 91 as a master. Similarly, the wireless LAN board 1 is attached to each industrial PC 92 and is connected to the existing wired LAN board 23 as described above, and the controller section 8 assigns each industrial PC as a slave.

With this configuration, in a production management system in which each industrial PC 92 is installed with a special OS, the host computer 91 can transmit/receive a data signal to/from each industrial PC 92 in a wireless manner with the host computer 91 used as a master. Further, since the host computer 91 and each industrial PC 92 perform wireless communications with each other, it is unnecessary to connect between the AP 83 and the host computer 91 and between the host computer 91 and each industrial PC 92 through a cable such as a LAN cable.

It is to be noted that the management computer 81 transmits/receives a data signal to/from the host computer 91 in a wireless manner through the AP 83 appropriately.

Now, description will be given of the WOL (Wake On LAN) function in the applied example 4. Herein, the wireless LAN board 1 attached to the host computer 91 is supplied with standby electric power from the auxiliary power supply connector 10.

For example, in the case that production management information extracted from the industrial PCs 92 in each working zone by the host computer 91 during the daytime is extracted from the host computer 91 after end of operations, the management computer 81 transmits a magic packet from the AP 83 to the wireless LAN board 1 of each host computer 91 to turn on the main power supply of each host computer 91, thereby extracting production management information of each host computer 91.

As described above, according to this embodiment, the data signal transmission source (e.g., motherboard) itself of the PC 21 transmits/receives a data signal to/from the existing wired LAN board 23 as conventionally, and the existing wired LAN board 23 transmits/receives a data signal to/from the wireless LAN board 1; therefore, it is unnecessary to provide driver software for wireless LAN. Thus, it is possible to omit burdensome work associated with loading of the driver software. In addition, since the wireless LAN board 1 can be used without depending on the kind of an OS installed in the PC 21, its general versatility can be improved. Further, since the wireless LAN board 1 does not require the driver software for wireless LAN as described above, it is unnecessary to perform processing of driver software for wireless LAN.

According to the aforementioned embodiment, the wireless LAN board 1 is fixed in such a manner that the PCI connector 11 thereof is attached to the PCI slot 22. Therefore, the wireless LAN board 1 can be fixed without modifying a PC main body or without using a fixing member such as a stay. In addition, since the wireless LAN board 1 is supplied with electric power from the PCI bus, it is unnecessary to provide an external power supply unit such as an AC adapter. Thus, it is possible to readily incorporate the wireless LAN board 1 into the PC 21.

According to the aforementioned embodiment, even in the case that terminal devices are installed with a special OS, respectively, the wireless LAN board 1 is attached to each of these terminal devices, so that each terminal device can be assigned as a master or a slave. Thus, it is possible to readily construct the existing PC 21 as a wireless LAN system. In addition, since wireless communications can be established between the terminal devices, it is unnecessary to connect between the terminal devices through a cable such as a LAN cable. Accordingly, it is possible to readily perform a change in layout of each terminal device, and other operations.

According to the aforementioned embodiment, since the controller section 8 performs processing such as data signal encryption/decryption, dispersed processing can be performed by the CPU of the PC 21 and the controller section 8. Even when the throughput of the PC 21 is low, this PC 21 can obtain sufficient transmission speed.

According to the aforementioned embodiment, the wireless LAN section 5 selects a radio signal from the sensitive one of the antennas 12. Therefore, even when a radio wave from one of the antennas 12 is interrupted due to movement of a person, and the like, so that the sensitivity deteriorates, it is possible to always receive a radio signal with accuracy.

According to the aforementioned embodiment, in the basic structures B and C in which the PC 21 is used as a master, the PDAs 41 and 61 are used as slaves. However, the present invention is not limited thereto. APC equipped with the wireless Larboard 1 may be used as a slave.

According to the aforementioned embodiment, the wireless LAN board 1 is provided with the auxiliary power supply connector 10, is supplied with standby electric power through the auxiliary power supply connector 10 in the WOL use, and is supplied with operating electric power after activation of the PC 21. However, the present invention is not limited thereto. The auxiliary power supply connector 10 is provided inside the PCI connector 11; thus, the wireless LAN board 1 may be supplied with standby electric power and operating electric power through the PCI connector 11. Alternatively, the wireless LAN board 1 may be supplied with standby electric power through the auxiliary power supply connector 10 and may be supplied with operating electric power through the PCI connector 11.

What is claimed is:

1. A wireless LAN unit comprising:
a wired LAN connecting terminal connected to a wired LAN unit of a terminal device;
a reception unit connecting terminal connected with a reception unit for performing radio signal transmission/reception;
a wired LAN section connected to the wired LAN connecting terminal to transmit/receive a data signal to/from the wired LAN unit;
a wireless LAN section connected to the reception unit connecting terminal to transmit/receive a data signal to/from an external device by use of a radio signal through the reception unit; and
a controller section connected to the wired LAN section and the wireless LAN section to control the wired LAN section and the wireless LAN section,
wherein the wireless LAN unit is used by being attached to the terminal device and connected to the wired LAN unit of the terminal device through a cable.

2. The wireless LAN unit according to claim 1, wherein the wireless LAN unit is attached to an extension slot of the terminal device and supplied with electric power from the terminal device through the extension slot.

3. The wireless LAN unit according to claim 1, further comprising an auxiliary power supply terminal supplied with standby electric power, wherein
the controller section has a function of transmitting an activation signal to the wired LAN unit when the standby electric power is supplied from the auxiliary power supply terminal and an activation signal for the terminal device is inputted from the wireless LAN section,.

4. The wireless LAN unit according to claim 1, wherein the controller section has a function of assigning the wireless LAN unit as a master or a slave.

5. The wireless LAN unit according to claim 1, wherein the controller section has a function of encrypting the data signal inputted from the wired LAN section and outputting the encrypted data signal to the wireless LAN section, and decrypting the data signal inputted from the wireless LAN section and outputting the decrypted data signal to the wired LAN section.

6. The wireless LAN unit according to claim 1, wherein the reception unit connecting terminals are two in number, and when the two reception unit connecting terminals are connected with reception units, respectively, the wireless LAN section has a function of selecting a radio signal from one of the reception units that has a better sensitivity.

7. The wireless LAN unit according to claim 2, further comprising an auxiliary power supply terminal supplied with standby electric power, wherein
the controller section has a function of transmitting an activation signal to the wired LAN unit when the standby electric power is supplied from the auxiliary power supply terminal and an activation signal for the terminal device is inputted from the wireless LAN section.

8. The wireless LAN unit according to claim 2, wherein the controller section has a function of assigning the wireless LAN unit as a master or a slave.

9. The wireless LAN unit according to claim 2,, wherein the controller section has a function of encrypting the data signal inputted from the wired LAN section and outputting the encrypted data signal to the wireless LAN section, and decrypting the data signal inputted from the wireless LAN section and outputting the decrypted data signal to the wired LAN section.

10. The wireless LAN unit according to claim 2, wherein the reception unit connecting terminals are two in number, and when the two reception unit connecting terminals are connected with reception units, respectively, the wireless LAN section has a function of selecting a radio signal from one of the reception units that has a better sensitivity.
